(19) United States
(12) Patent Application Publication
(10) Pub. No.: US 2025/0285252 A1
(43) Pub. Date: Sep. 11, 2025

(54) APPARATUS FOR PREDICTING ABNORMALITY AND METHOD THEREOF

(71) Applicant: RESEARCH & BUSINESS FOUNDATION SUNGKYUNKWAN UNIVERSITY, Suwon-si (KR)

(72) Inventors: Jang Won LEE, Seoul (KR); In Pyo SONG, Seoul (KR); Min Jun JU, Seoul (KR); Jonn Hyung KWON, Seoul (KR)

(21) Appl. No.: 19/062,397

(22) Filed: Feb. 25, 2025

(30) Foreign Application Priority Data
Mar. 5, 2024 (KR) 10-2024-0031055

(51) Int. Cl. G06T 7/00; G06T 7/215; G06T 7/246; G06T 7/73; G06V 10/77; G06V 10/82

(52) U.S. Cl. CPC G06T 7/0002; G06T 7/215; G06T 7/246; G06T 7/73; G06V 10/7715; G06V 10/82; G06T 2207/20016; G06T 2207/20081; G06T 2207/20084

(57) ABSTRACT

The present invention relates to an apparatus for predicting abnormality and a method thereof, the method comprises generating a feature map based on a previously captured omnidirectional image, generating a masked image based on the feature map, extracting a snippet feature based on the omnidirectional image, extracting a frame feature based on the masked image and predicting a direction of an abnormality using the feature map and a combined feature obtained by combining the snippet feature and the frame feature.

### CROSS-REFERENCE TO RELATED APPLICATION

This application claims the priority benefit of Korean Patent Application No. 10-2024-0031055 filed on Mar. 5, 2024 in the Korean Intellectual Property Office, the disclosures of which are incorporated herein by reference.

### BACKGROUND

### 1. Field

The present invention relates to an apparatus for predicting an abnormality and a method thereof.

### 2. Description of the Related Art

Recently, with advancements in computer vision, research on predictive technologies for abnormal situations has been actively conducted.

In a task of identifying a frame in which an abnormal event occurs in an image, there are generally unsupervised and weakly supervised approaches.

The unsupervised approach is a method of training a network using only normal images without annotations, and the weakly supervised approach uses image-level labels for training, but there is a problem that annotations are limited.

Recently, interest in the weakly supervised approach has increased, and the weakly supervised approach has shown promising performance in an open benchmark dataset.

However, the weakly supervised approach has a problem in that it is difficult to identify abnormal activities in a rapidly changing situation.

In addition, since the weakly supervised approach predicts an abnormality score for a simple segment extracted from an image, there is a problem in that the same abnormality score is generally allocated to a predetermined number of frames, and the abnormality score is often excessively generalized.

Therefore, this weakly supervised approach has a problem of having difficulty in identifying a sudden abnormality.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The objective of the present invention is to provide an apparatus for predicting an abnormality and a method thereof, capable of predicting an abnormality using an omnidirectional image and predicting a direction in which the abnormality occurs by giving a direction label for each direction of the omnidirectional image.

To solve the aforementioned problems, an apparatus and a method for predicting abnormality are provided.

A method for predicting an abnormality comprises generating a feature map based on a previously captured omnidirectional image, generating a masked image based on the feature map, extracting a snippet feature based on the omnidirectional image, extracting a frame feature based on the masked image and predicting a direction of an abnormality using the feature map and a combined feature obtained by combining the snippet feature and the frame feature.

The omnidirectional image is converted into an image in which a region is divided according to a direction label assigned to the omnidirectional image.

The predicting a direction of an abnormality comprises calculating a direction score corresponding to the direction label based on the combined feature, calculating a pixel feature score in a grid by applying a feature map to the direction score and predicting the direction of the abnormality based on the pixel feature score.

The predicting the direction of the abnormality comprises predicting the direction of the abnormality using a direction focus loss.

The generating of the feature map comprises generating the feature map by identifying a dynamic region in the omnidirectional image.

The generating of the masked image comprises dividing the feature map into grids, calculating a feature score by summing pixel values in each cell of the grid, selecting a plurality of upper cells having the highest score in the feature score and generating the masked image by masking cells other than the plurality of upper cells.

The method for predicting an abnormality further comprises calculating a snippet level feature based on the snippet feature, calculating a coarse anomaly score using the snippet level feature and calculating a frame virtual label based on the coarse anomaly score.

The calculating a frame virtual label comprises predicting an abnormality when the coarse anomaly score is equal to or greater than a threshold.

The method for predicting an abnormality further comprises extracting a frame-level feature based on the frame feature and calculating a fine anomaly score based on the frame-level feature.

The method for predicting an abnormality further comprises learning a loss function by using the frame virtual label calculation and the fine anomaly score.

An apparatus for predicting an abnormality comprises a processor comprising a generator configured to generate a feature map based on a previously captured omnidirectional image and generate a masked image based on the feature map, a snippet level predictor configured to extract a snippet feature based on the omnidirectional image, a frame level predictor configured to extract a frame feature based on the masked image and a direction predictor configured to predict a direction of an abnormality using the feature map and a combined feature obtained by combining the snippet feature and the frame feature.

The omnidirectional image is converted into an image in which a region is divided according to a direction label assigned to the omnidirectional image.

The direction predictor is configured to calculate a direction score corresponding to the direction label based on the combined feature, calculate a pixel feature score in a grid by applying a feature map to the direction score, and predict the direction of the abnormality based on the pixel feature score.

The direction predictor is configured to predict the direction of the abnormality using a direction focus loss.

The generator is configured to generate the feature map by identifying a dynamic region in the omnidirectional image.

The generator is configured to divide the feature map into grids, calculate a feature score by summing pixel values in each cell of the grid, select a plurality of upper cells having the highest score in the feature score, and generate the masked image by masking cells other than the plurality of upper cells.

The snippet level predictor is configured to calculate a snippet level feature based on the snippet feature, calculate a coarse anomaly score using the snippet level feature, and calculate a frame virtual label based on the coarse anomaly score.

The snippet level predictor is configured to predict an abnormality when the coarse anomaly score is equal to or greater than a threshold.

The frame level predictor is configured to extract a frame-level feature based on the frame feature and calculate a fine anomaly score based on the frame-level feature.

The frame level predictor is configured to learn a loss function by using the frame virtual label calculation and the fine anomaly score.

According to the above-described apparatus for predicting an abnormality and method thereof, it is possible to detect abnormal situations in a 360-degree omnidirectional view, effectively process the large amount of information generated from omnidirectional images, and achieve accurate frame-level prediction with minimal labeling in the field of anomaly detection, where data collection is challenging. This enables the detection of abnormalities that occur within a relatively short period.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram for describing a configuration of an apparatus for predicting an abnormality according to an embodiment of the present invention.

FIGS. 2 and 3 are diagrams for describing an omnidirectional image according to an embodiment of the present invention.

FIG. 4 is a diagram for describing a feature map and a masked image according to an embodiment of the present invention.

FIG. 5 is a diagram for describing a snippet level prediction according to an embodiment of the present invention.

FIG. 6 is a diagram for describing a fine anomaly score for a frame level according to an embodiment of the present invention.

FIG. 7 is a diagram for describing a binary loss function according to an embodiment of the present invention.

FIG. 8 is a diagram for describing a frame ranking loss according to an embodiment of the present invention.

FIG. 9 is a diagram for describing a direction prediction according to an embodiment of the present invention.

FIG. 10 is a flowchart illustrating a method for predicting an abnormality according to an embodiment of the present disclosure.

FIG. 11 is a flowchart illustrating a method for predicting an abnormality using a snippet feature according to an embodiment of the present invention.

FIG. 12 is a flowchart illustrating a method of calculating a fine anomaly score using a frame feature according to an embodiment of the present invention.

FIGS. 13, 14, 15, and 16 are diagrams for describing performance of an apparatus for predicting abnormality according to an embodiment of the present invention

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, as well as methods for achieving them, will become apparent by referring to the embodiments described below in conjunction with the accompanying drawings. However, the present invention is not limited to the embodiments disclosed herein and may be implemented in various different forms. The embodiments are provided merely to ensure a complete disclosure of the present invention and to fully convey the scope of the invention to those skilled in the art. The present invention is solely defined by the scope of the claims.

The terms used in the present specification will be briefly described, followed by a detailed description of the present invention.

The terms used in the present invention have been selected, to the extent possible, from widely used general terms while considering their functions within the present invention. However, such terms may vary depending on the intent of those skilled in the art, judicial precedents, or the emergence of new technologies. In certain cases, terms may be arbitrarily selected by the applicant, in which case their meanings will be described in detail in the corresponding description of the invention. Accordingly, the terms used in the present invention should be interpreted based on their meanings and the overall context of the present invention, rather than merely on their names.

Throughout the present specification, when a certain component is described as “including” another component, it should be understood that, unless explicitly stated otherwise, the component may further include additional components rather than excluding them. Furthermore, the terms “unit,” “module,” and “part,” as used in the present specification, refer to components that process at least one function or operation. These components may be implemented as software, hardware components such as an FPGA or ASIC, or a combination of software and hardware. However, the terms “unit,” “module,” and “part” are not limited to software or hardware alone. These components may be configured to be stored in an addressable storage medium or to execute one or more processors. For example, the terms “unit,” “module,” and “part” may encompass software components, object-oriented software components, class components, and task components, as well as processes, functions, attributes, procedures, subroutines, program code segments, drivers, firmware, microcode, circuits, data, databases, data structures, tables, arrays, and variables.

Hereinafter, embodiments of the present invention will be described in detail with reference to the accompanying drawings to enable those skilled in the art to readily implement the invention. For clarity, parts unrelated to the description of the present invention are omitted in the drawings.

Terms including ordinal numbers, such as “first” and “second,” may be used to describe various components. However, these components are not limited by such terms, which are used merely to distinguish one component from another. For example, within the scope of the present invention, a “first” component may alternatively be referred to as a “second” component, and vice versa. The term “and/or” includes both a combination of multiple related items and any one of the multiple related items. Hereinafter, an apparatus for predicting an abnormality according to an embodiment of the present invention will be described with reference to the drawings.

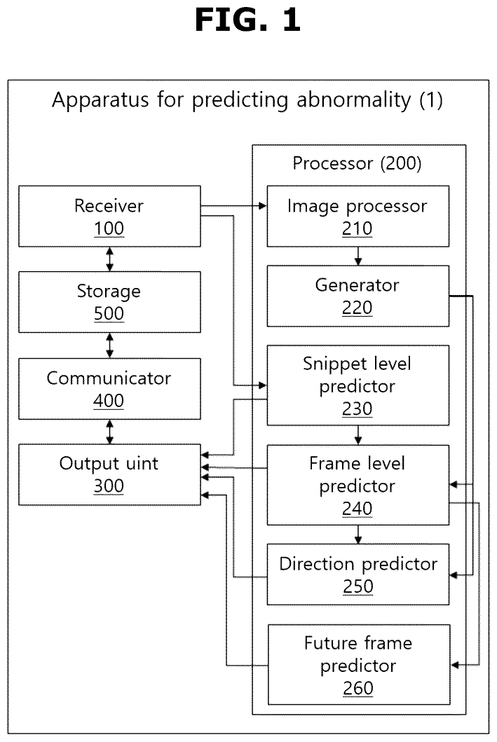

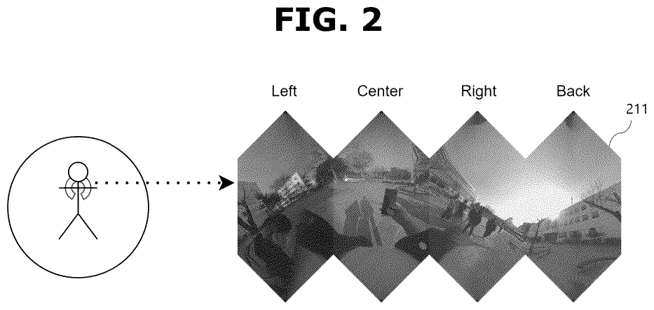

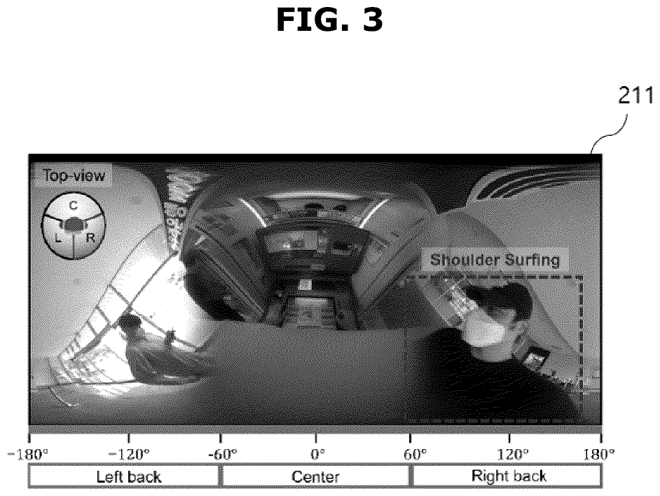

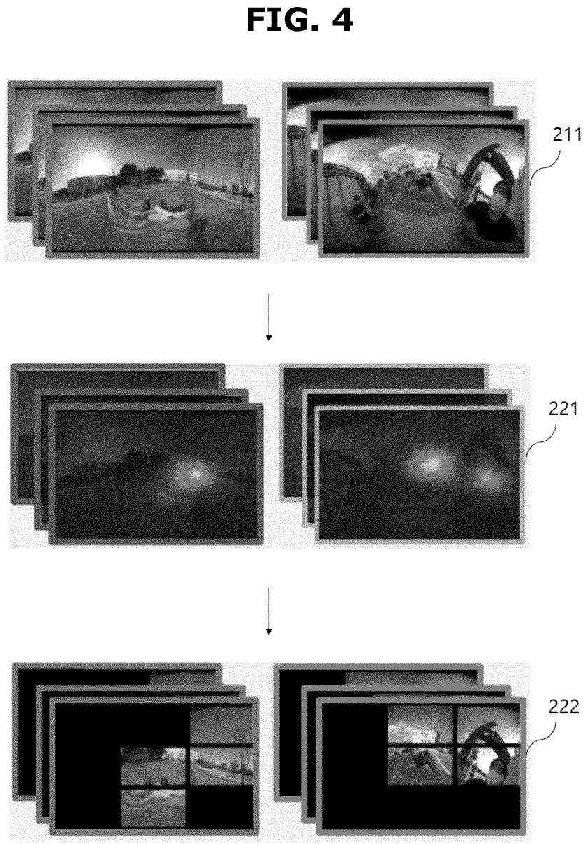

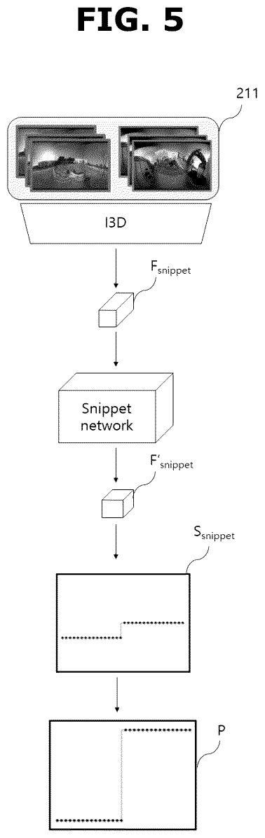

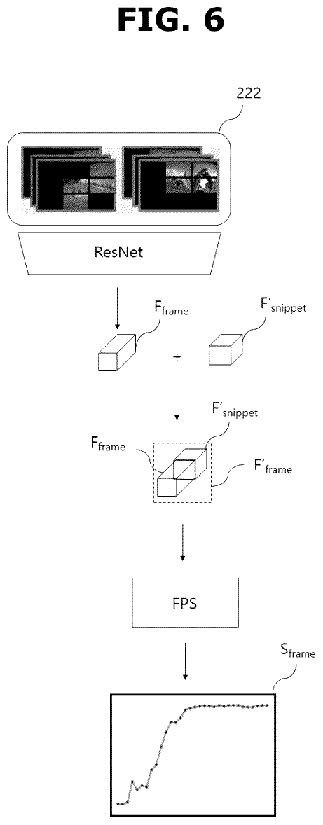

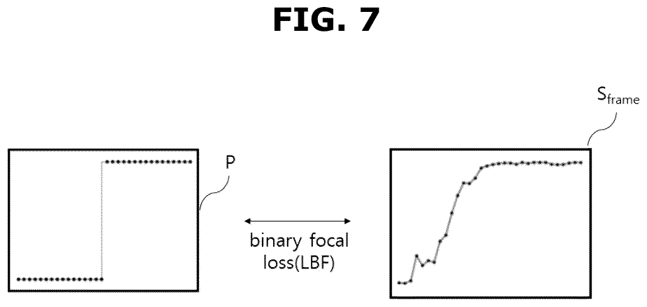

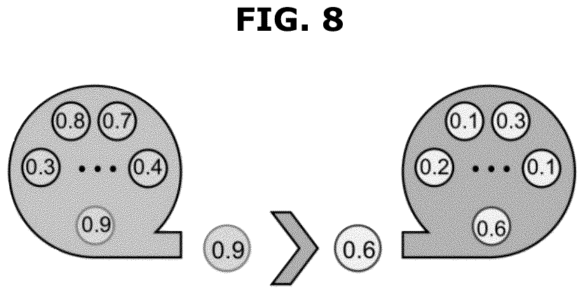

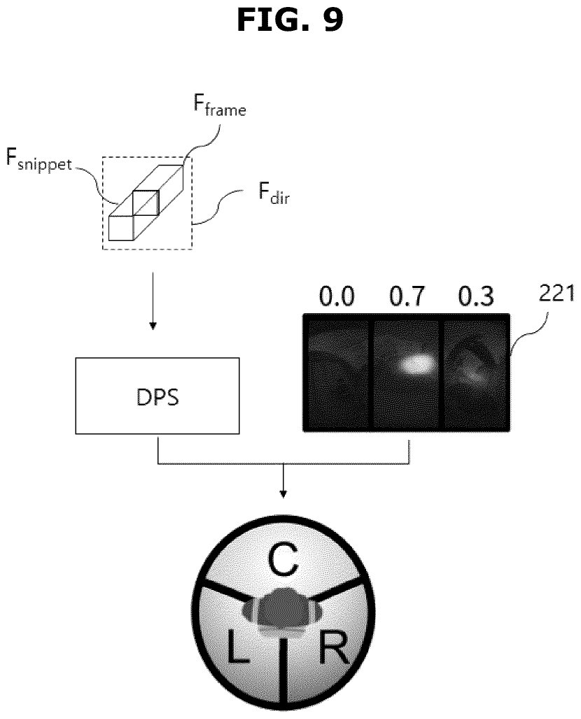

FIG. 1 is a block diagram for describing a configuration of an apparatus for predicting an abnormality according to an embodiment of the present invention, FIGS. 2 and 3 are diagrams for describing an omnidirectional image according to an embodiment of the present invention, FIG. 4 is a diagram for describing a feature map and a masked image according to an embodiment of the present invention, FIG. 5 is a diagram for describing a snippet level prediction according to an embodiment of the present invention, FIG. 6 is a diagram for describing a fine anomaly score for a frame level according to an embodiment of the present invention, FIG. 7 is a diagram for describing a binary loss function according to an embodiment of the present invention, FIG. 8 is a diagram for describing a frame ranking loss according to an embodiment of the present invention, and FIG. 9 is a diagram for describing a direction prediction according to an embodiment of the present invention.

As shown in FIG. 1, an apparatus for predicting an abnormality 1 includes a receiver 100, a processor 200, an output unit 300, a communicator 400, and a storage 500.

The communicator 400 may allow the receiver 100, the processor 200, the output unit 300, and the storage 500 to transmit and receive data to and from each other.

For example, the communicator 400 may be implemented using at least one communication module (e.g., a LAN card, a short-range communication module, or a mobile communication module).

The communicator 400 includes both wired and wireless communication networks. For example, a wired/wireless Internet network may be used or linked as the communicator 400. Here, the wired Internet network includes an Internet network such as a cable network or a public telephone network (PSTN), and the wireless Internet network includes CDMA, WCDMA, GSM, Evolved Packet Core (EPC), Long Term Evolution (LTE), a Wibro network, a 5G communication network, and the like. Of course, the communicator 400 according to an embodiment of the present disclosure is not limited thereto, and may be used as an access network of a next-generation mobile communication system to be implemented in the future, for example, a cloud computing network under a cloud computing environment, a 5G network, or the like. For example, when the communicator 400 is a wired communication network, an access point in the communication network may access an exchange station of a telephone station, and the like, but when the communicator 400 is a wireless communication network, the access point may access an SGSN or a Gateway GPRS Support Node (GGSN) operated by a communication company to process data, or may access various repeaters such as Base Station Transmission (BST), NodeB, e-NodeB, and the like to process data.

The storage 500 may store the received omnidirectional image.

The storage 500 may store a direction label assigned to an omnidirectional image, and store a feature map and a masked image.

The storage 500 may store a snippet feature, a snippet level feature, a coarse anomaly score, and a frame virtual label.

The storage 500 may store a frame feature, a frame level feature, and a fine anomaly score.

The storage 500 may store a direction of the abnormality

The storage 500 may include at least one of a main memory device and an auxiliary memory device. The main memory device may be implemented using a semiconductor storage medium such as, for example, ROM and/or RAM, and the auxiliary memory device may be implemented based on a device capable of permanently or semi-permanently storing data, such as a flash memory device (a Solid State Drive (SSD)), a Secure Digital (SD) card, a Hard Disc Drive (HDD), a compact disk, a Digital Versatile Disk (DVD), a laser disk, or the like.

The receiver 100 receives an omnidirectional image captured by a 360-degree wearable camera.

Here, the omnidirectional image may be composed of a plurality of frames.

The processor 200 may include an image processor 210, a generator 220, a snippet level predictor 230, a frame level predictor 240, and a direction predictor 250.

The image processor 210 may assign a direction label to the received omnidirectional image, and convert the omnidirectional image into an image, the region of which is divided according to the direction label.

Here, the direction label may include at least one of left, center, right, back, left back, and right back.

The image processor 210 may convert the omnidirectional image into a single image for direction prediction through an image stitching process.

Here, the image represents a frame of an image.

In an embodiment, as shown in FIG. 2, the image processor 210 may divide the omnidirectional image by 90 degrees to assign direction labels including left, center, right, and back, and convert the omnidirectional image into an image 211 divided into a plurality of regions according to the direction labels.

In another exemplary embodiment, as illustrated in FIG. 3, the image processor 210 may assign a direction label including a left back and a right back to the omnidirectional image, and convert the omnidirectional image into an image 211 that is divided into a plurality of regions according to the direction label.

That is, the image processor 210 may convert the omnidirectional image into an image divided into a plurality of regions corresponding to the direction labels to distinguish the directions

The generator 220 may generate a masked image 222 based on the omnidirectional image 211.

Here, the omnidirectional image 211 may be an image composed of a frame divided into a plurality of regions according to a direction label.

Specifically, the generator 220 may identify a dynamic region based on the omnidirectional image 211.

The generator 220 may identify a region with a relatively movement except for a static region in the omnidirectional image 211.

Here, the dynamic region represents a notable region in which abnormality may be included.

As shown in FIG. 4, the generator 220 may generate a feature map 221 based on a dynamic region in which there is a relative movement in the omnidirectional image 211, and may generate a masked image 222 based on the feature map.

The feature map 221 represents visual importance in the image, and each pixel value of the feature map 221 may represent a feature score at a coordinate in the omnidirectional image.

The generator 220 may divide the feature map 221 into n×n grids, and calculate a feature score by summing pixel values in each cell of the grid.

Here, each cell of the grid may be represented by an integer.

The generator 220 may generate the masked image 222 by identifying the top K remarkable cells having the highest score in the feature score and allocating a value of 1 to the top k cells and a value of 0 to the remaining cells.

That is, the generator 220 may generate the masked image by selecting a plurality of upper cells having the highest score in the feature score and masking the remaining cells.

Meanwhile, the snippet level predictor 230 extracts a snippet feature based on a plurality of frames included in the omnidirectional image 211.

As shown in FIG. 5, the snippet level predictor 230 may extract a snippet feature Fₛₙᵢₚₚₑₜ based on segments of a plurality of frames included in an omnidirectional image.

Specifically, the snippet level predictor 230 may input the segments of the plurality of frames to a segment feature extractor to extract one snippet feature Fₛₙᵢₚₚₑₜ containing information on the plurality of frames

Here, the segment feature extractor is a 3D convolution-based network, and may be an Inflated 3D convnet (I3D) or an Convolutional 3D (C3D).

The snippet level predictor 230 may calculate a snippet level feature F′snippet based on the snippet feature Fₛₙᵢₚₚₑₜ.

The snippet level predictor 230 may input the snippet feature Fₛₙᵢₚₚₑₜ to a Snippet network and output a snippet level feature F′ₛₙᵢₚₚₑₜ.

The snippet level predictor 230 may calculate a coarse anomaly score Sₛₙᵢₚₚₑₜ using the snippet level feature F′snippet.

In other words, the snippet level predictor 230 may calculate a coarse anomaly score Sₛₙᵢₚₚₑₜ for a plurality of frames in the omnidirectional image.

Here, the snippet level predictor 230 may be trained in a MIL wealy-supervised learning form by an image label with respect to a process of calculating a coarse anomaly score Sₛₙᵢₚₚₑₜ.

The snippet level predictor 230 may calculate the frame virtual label P by assigning 0 when the coarse anomaly score Sₛₙᵢₚₚₑₜ is less than a threshold or normal video, and assigning 1 when the coarse anomaly score is equal to or greater than the threshold using Equation 1 below

Here, the normal image refers to an image in which an abnormality is not included.

$$\{ \begin{matrix}0 if score < threshold or normal video \\ 1 if score \geq threshold\end{matrix} \qquad [ Equation 1 ]$$

That is, when the coarse anomaly score is equal to or greater than the threshold, the snippet level predictor 230 may predict the abnormality by assigning the frame virtual label P to 1.

The frame level predictor 240 extracts a plurality of frame features of each of the plurality of frames based on the masked image 222.

As shown in FIG. 6, the frame level predictor 240 may input the masked image 222 to a frame feature extractor to extract a plurality of frame features F_{frame}.

Here, the frame feature extractor may be ResNet.

The frame level predictor 240 may extract a frame-level feature F′_{frame} by combining the plurality of frame features F_{frame} and the snippet-level feature F′ₛₙᵢₚₚₑₜ.

The frame level predictor 240 may calculate a fine anomaly score S_{frame} based on the frame level feature F′_{frame}.

The frame level predictor 240 may calculate a fine anomaly score S_{frame} for a frame by inputting the frame level feature F′_{frame} to a frame anomaly detector.

Here, the frame anomaly detector may be a frame prediction subnetwork (FPS).

The frame level predictor 240 may detect the direction of the abnormality when the fine anomaly score exceeds the threshold.

Here, the threshold may be a preset situation score value.

The frame level predictor 240 may generate a frame virtual label P.

The frame level predictor 240 may learn the frame virtual label P by using ground-truth, and may learn a loss by using a binary focal loss (L_{BF}).

The frame level predictor 240 may learn a loss function using the frame virtual label P and the fine anomaly score S_{frame}.

As shown in FIG. 7, the binary loss function may be learned by comparing the frame virtual label P with the fine anomaly score S_{frame} using the focusing parameter γ.

The binary loss function may be learned using Equation 2 below.

$${L}_{BF} = - {P ( 1 - {S}_{frame} )}^{γ} log ( {S}_{frame} ) - ( 1 - P ) {S}_{frame}^{γ} log ( 1 - {S}_{frame} ) \qquad [ Equation 2 ]$$

Here, L_{BF} denotes a binary loss function, P denotes a frame virtual label, S_{frame} denotes a fine anomaly score, and γ denotes a focusing parameter.

Also, the frame level predictor 240 may use a frame ranking loss (L_{FR}) and a Smoothness Loss (Lₛₘₒₒₜₕ).

As shown in FIG. 8, the frame ranking loss (L_{FR}) may be learned by assigning a priority to the upper R frame having the highest fine anomaly score in the positive image and the negative image, moving the fine anomaly score of the positive image to 1, and moving the fine anomaly score of the negative image to 0.

The frame ranking loss may be learned using Equation 3 below.

$${L}_{FR} = \frac{1}{R} {\sum }_{γ = 1}^{R} ( 1 - {S}_{frame , γ}^{+} + {S}_{frame , γ}^{-} ) \qquad [ Equation 3 ]$$

Here, L_{FR} denotes a frame ranking loss, R denotes a priority, S⁺_{frame,γ} denotes a fine anomaly score of a positive image, and S⁻_{frame,γ} denotes a fine anomaly score of a negative image.

In addition, the Smoothness Loss Lₛₘₒₒₜₕ may penalize a sudden change in a predicted fine anomaly score to ensure a smooth transition between adjacent frames.

The smoothness loss may be calculated for all frames using Equation 4 below.

$${L}_{smooth} = \frac{1}{F} {\sum }_{f = 1}^{F} {( {S}_{frame}^{f} - {S}_{frame}^{f - 1} )}^{2} \qquad [ Equation 4 ]$$

Here, Lₛₘₒₒₜₕ denotes a smoothness loss, a denotes the number of all frames of an image, S′_{frame} denotes a fine anomaly score of an f th frame, and S^{f-1}_{frame} denotes a fine anomaly score of an f−1 th frame.

As described above, in an embodiment of the present invention, the smoothness loss Lₛₘₒₒₜₕ may be applied to a fine anomaly score of a frame.

The direction predictor 250 may predict a direction based on the snippet feature Fₛₙᵢₚₚₑₜ and the frame feature F_{frame}.

The direction predictor 250 may predict a direction of an abnormality using the feature map and the combined feature Fair obtained by combining the snippet feature Fₛₙᵢₚₚₑₜ and the frame feature F_{frame}.

As shown in FIG. 9, the direction predictor 250 may input the combined feature F_{dir} obtained by combining the snippet feature Fₛₙᵢₚₚₑₜ and the frame feature F_{frame} to a direction prediction subnetwork (DPS), and may predict the abnormality direction by applying the feature map 221.

Here, the DPS may use the subnetwork of the same Poolformer-based architecture as the FPS.

The direction predictor 250 may predict a score (probability) value for each direction.

The direction predictor 250 may calculate a direction score corresponding to the direction label by inputting the combined feature Fair to the DPS, and may calculate a pixel feature score in the grid by applying the soft max of the feature map 221 to the direction score.

For example, when the scores of the respective directions for Back, Left, Center, and Right of the omnidirectional image are [0.05, 0.15, 0.6, 0.2], the direction predictor 250 may predict the final direction prediction value by adding the score obtained by summing the feature map 221 generated from the generator 220 and the direction.

Here, the final direction prediction value may be a pixel feature score.

The direction predictor 250 may enhance the prediction for direction of abnormality in response to the pixel feature point in the grid.

The direction predictor 250 may learn a Directional Focal Loss (LDF) function using the same focusing parameter γ in relation to direction prediction.

The direction focus loss may be calculated as shown in Equation 5 below.

$${L}_{DF} = - {\sum }_{k = 1}^{c} {yk ( 1 - p k )}^{γ} log ( p k ) \qquad [ Equation 5 ]$$

Here, C denotes a direction of a direction label of an omnidirectional image, yk denotes a ground truth label for the direction, and pk denotes a prediction probability for the corresponding direction.

Here, the focusing parameter γ is shared with the binary focus loss, and the class contribution to the loss can be adjusted.

The total loss Lₜₒₜₐₗ may be calculated using Equation 6 below.

$${L}_{total} = {L}_{BF} + {λ}_{1} {L}_{FR} + {λ}_{2} {L}_{smooth} + {λ}_{3} {L}_{DF} \qquad [ Equation 6 ]$$

Here, L_{BF} is a binary loss function, L_{FR} is a frame ranking loss, Lₛₘₒₒₜₕ is a smoothness loss, LDF is a direction focus loss, and λ₁, λ₂ and λ₃ each represent a weight factor for the loss function.

The future frame predictor 260 may predict n future frame features using the frame features extracted from the frame level predictor 240.

The future frame predictor 260 may predict the n future frames in an autoregressive form based on the temporal flow learned through n frames based on the RNN-based structure. Here, the RNN-based structure may be GRU, LSTM, or the like.

The future frame predictor 260 may input the frame feature Fₜ₊ᵢ (where i=0, 1, . . . , n−1) at time t+i to the RNN-based structure to predict the future frame feature \hat{F}ₜ₊ₙ₊ⱼ at time t+n+j.

The future frame predictor 260 may learn the frame feature Fₜ₊ₙ₊ⱼ at the actual time t+n+j as ground-truth.

The future frame predictor 260 may predict the future frame feature \hat{F}ₜ₊ₙ₊ⱼ at the time t+n+j through Equation 7 below.

$${\hat{F}}_{t + n + j} = RNN ( {F}_{t + n + j - 1} , {S}_{t + n + j - 1} , ) , for j - 0 , 1 , … , n - 1 \qquad [ Equation 7 ]$$

Here \hat{F}ₜ₊ₙ₊ⱼ is the future frame feature at time t+n+j, Fₜ₊ₙ₊ⱼ₋₁ is the frame feature at actual time t+n+j−1, and Sₜ₊ₙ₊ⱼ₋₁ is the fine anomaly score at actual time t+n+j−1.

The future frame predictor 260 may calculate and learn a loss using MSE loss and Cosie similarity-based loss.

The future frame predictor 260 may calculate MSE loss through Equation 8 below.

$$M S E = \frac{1}{n} {\sum }_{j = 0}^{n - 1} {‖ {F}_{t + n + j} - {\hat{F}}_{t + n + j} ‖}^{2} \qquad [ Equation 8 ]$$

Here, Fₜ₊ₙ₊ⱼ denotes a frame feature at an actual time t+n+j, and \hat{F}ₜ₊ₙ₊ⱼ denotes a future frame feature at a time t+n+j.

The future frame predictor 260 may calculate Cosine loss through Equation 9 below.

$$Cosine loss = \frac{1}{n} {\sum }_{j = 0}^{n - 1} ( 1 - \frac{{F}_{t + n + j} \cdot {\hat{F}}_{t + n + j}}{‖ {F}_{t + n + j} ‖ ‖ {\hat{F}}_{t + n + j} ‖} ) \qquad [ Equation 9 ]$$

Here, Fₜ₊ₙ₊ⱼ denotes a frame feature at an actual time t+n+j, and \hat{F}ₜ₊ₙ₊ⱼ denotes a future frame feature at a time t+n+j.

The output unit 300 may output the frame virtual label calculated from the snippet level predictor 230.

The output unit 300 may output a fine anomaly score for the frame calculated from the frame level predictor 240.

The output unit 300 may output the direction of abnormality predicted by the direction predictor 250.

The output unit 300 may include, for example, a display, a printer device, a speaker device, an image output terminal, a data input/output terminal, or a communication module, but is not limited thereto.

If necessary, the output unit 300 may be provided integrally with the receiver 100.

Hereinafter, a method for predicting an abnormality according to an embodiment of the present invention will be described with reference to the drawings.

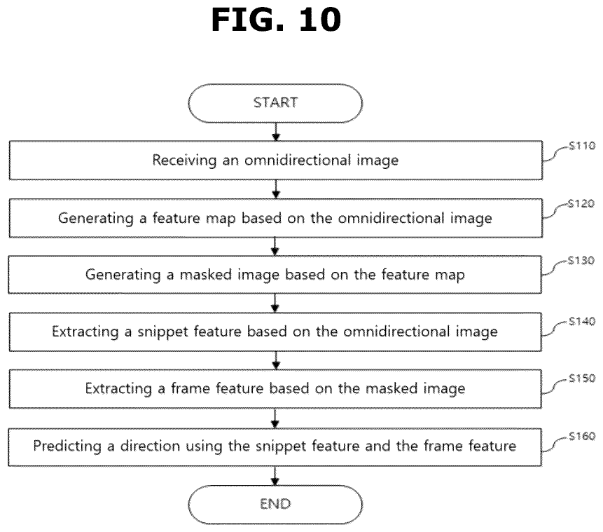

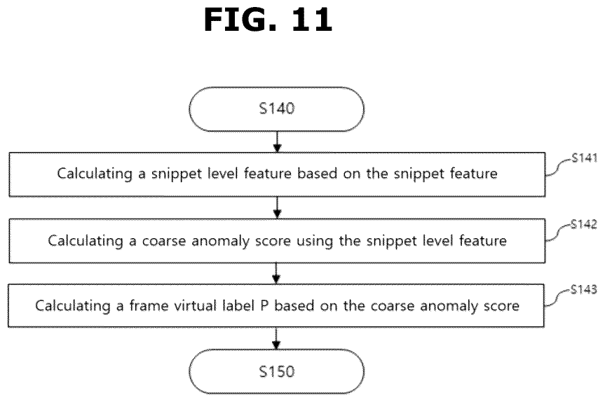

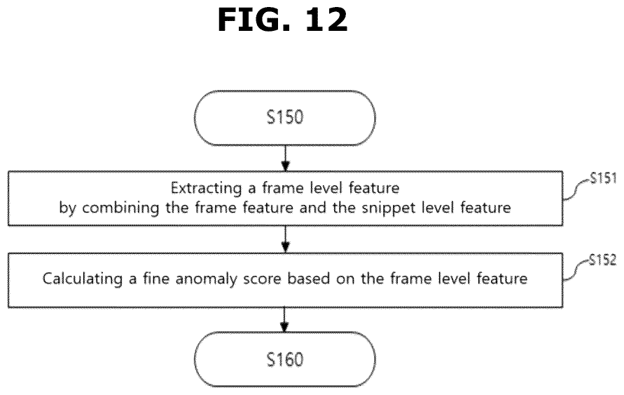

FIG. 10 is a flowchart illustrating a method for predicting an abnormality according to an embodiment of the present invention, FIG. 11 is a flowchart illustrating a method for predicting an abnormality using a snippet feature according to an embodiment of the present invention, and FIG. 12 is a flowchart illustrating a method of calculating a fine anomaly score using a frame feature according to an embodiment of the present invention.

The receiver 100 receives an omnidirectional image captured by a 360-degree camera (S110).

Here, the omnidirectional image may be composed of a plurality of frames.

The image processor 210 may assign a direction label to the received omnidirectional image, and convert the omnidirectional image into an image, the region of which is divided according to the direction label.

Here, the direction label may include at least one of left, center, right, back, left back, and right back.

Operation S110 has already been described in the receiver 100 and the image processor 210 of FIGS. 1 to 3, and thus a redundant description thereof will be omitted.

The generator 220 identifies a dynamic region on the basis of the omnidirectional image and generates a feature map (S120).

Here, the dynamic region represents a notable region in which abnormality may be included.

Each pixel value of the feature map may indicate a feature score at a coordinate in the directional omnidirectional image.

The generator 220 generates a masked image based on the feature map (S130).

The generator 220 may divide the feature map 221 into n×n grids, and calculate a feature score by summing pixel values in each cell of the grid.

The generator 220 may generate a masked image by identifying the top K remarkable cells having the highest score in the feature score and assigning a value of 1 to the top k cells and a value of 0 to the remaining cells.

Operations S120 and S130 have already been described in the generator 220 of FIGS. 1 and 4, and thus a redundant description thereof will be omitted.

The snippet level predictor 230 extracts a snippet feature based on the omnidirectional image (S140).

The snippet level predictor 230 may extract a snippet feature Fₛₙᵢₚₚₑₜ based on a segment of a plurality of frames included in the omnidirectional image.

More specifically, the snippet level predictor 230 calculates a snippet level feature F′ₛₙᵢₚₚₑₜ based on the snippet feature Fₛₙᵢₚₚₑₜ (S141).

Here, the snippet level predictor 230 may input the snippet feature Fₛₙᵢₚₚₑₜ to a Snippet network and output a snippet level feature F′ₛₙᵢₚₚₑₜ.

The snippet level predictor 230 calculates a coarse anomaly score Sₛₙᵢₚₚₑₜ using the snippet level feature F′ₛₙᵢₚₚₑₜ (S142).

The snippet level predictor 230 calculates a frame virtual label P based on the coarse anomaly score (S143).

The snippet level predictor 230 may calculate the frame virtual label P by assigning 0 when the coarse anomaly score is less than a threshold or a normal video, and assigning 1 when the coarse anomaly score is equal to or greater than the threshold.

As described above, the snippet level predictor 230 may predict an abnormality by allocating 1 when the coarse anomaly score is equal to or greater than the threshold.

Since steps S140 to S143 have already been described with reference to FIGS. 1 and 5, a redundant description thereof will be omitted.

The frame level predictor 240 extracts frame features of each of the plurality of frames on the basis of the masked image (S150).

The frame level predictor 240 may input the masked image 222 to the frame feature extractor to extract the plurality of frame features F_{frame}.

More specifically, the frame level predictor 240 extracts a frame level feature F′_{frame} by combining the plurality of frame features F_{frame} and the snippet level feature F′ₛₙᵢₚₚₑₜ (S151).

The frame level predictor 240 calculates a fine anomaly score S_{frame} based on the frame level feature F′_{frame} (S152).

The frame level predictor 240 may calculate a fine anomaly score S_{frame} for a frame by inputting the frame level feature F′_{frame} to a frame prediction subnetwork (FPS).

Since steps S150 to S152 have already been described with reference to FIGS. 1 and 6, a redundant description will be omitted.

The direction predictor 250 predicts a direction based on the snippet feature Fₛₙᵢₚₚₑₜ and the frame feature F_{frame} (S160).

The direction predictor 250 may input the combined feature Fair obtained by combining the snippet feature Fₛₙᵢₚₚₑₜ and the frame feature F_{frame} to a direction prediction subnetwork (DPS), and may predict the direction of abnormality by applying the feature map 221.

The direction predictor 250 may calculate a direction score corresponding to the image label by inputting the combined feature Fair to the DPS, and may calculate a pixel feature score in the grid by applying the soft max of the feature map 221.

In this way, the method for predicting an abnormality according to an embodiment of the present disclosure may predict an abnormality and predict the direction of abnormality.

In the method for predicting an abnormality according to an embodiment of the present invention, steps S110 to S160, steps S141 to S143, and steps S151 to S153 are described step by step, but may be performed simultaneously.

Hereinafter, the performance of an apparatus for predicting an abnormality according to an embodiment of the present invention will be described with reference to the drawings.

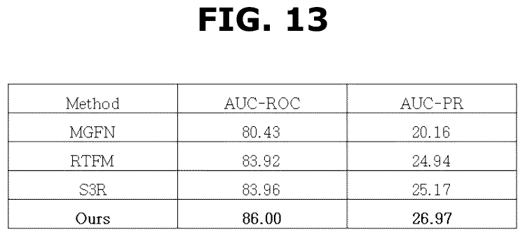

FIGS. 13 to 16 are diagrams for describing performance of an apparatus for predicting an abnormality according to an embodiment of the present invention.

As shown in FIG. 13, it can be seen that AUC-ROC and AUC-PR of the present invention (Ours) are 86.00% and 26.97%, respectively, which are improved compared to the related art (MGFN, RTFM, S3R).

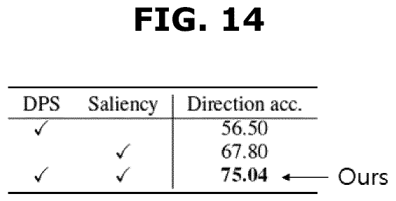

As shown in FIG. 14, the direction prediction according to the exemplary embodiment of the present invention has an accuracy of about 75.04%, which is more improved than that of the related art.

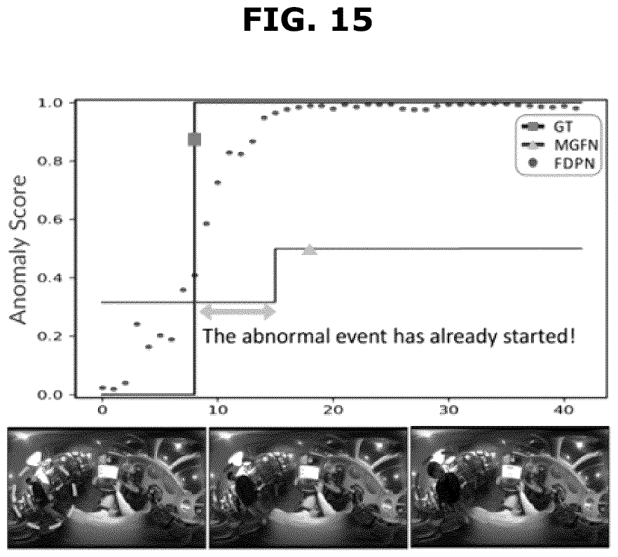

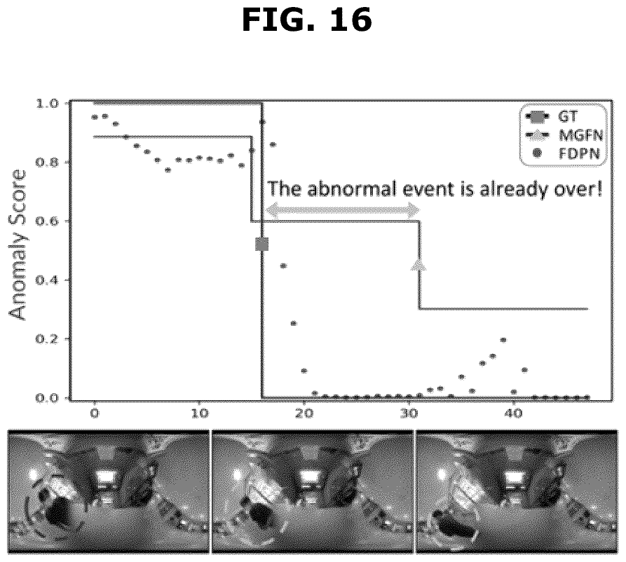

As shown in FIG. 15 and FIG. 16, it can be seen that the present invention shows more accurate abnormality detecting performance than the prior art.

As described above, according to the present disclosure, it is possible to detect an abnormality of 360 degrees omnidirectional, effectively process a large amount of information generated in an omnidirectional image, and accurately predict a frame level only with a small labeling requirement in an abnormal detection technical field in which it is difficult to collect data, thereby detecting an abnormality occurring in a relatively short time.

It will be understood by those skilled in the art related to the embodiments of the present invention that modifications can be made without departing from the essential characteristics described herein. Accordingly, the disclosed methods should be considered in a descriptive sense rather than a restrictive sense. The scope of the present invention is defined by the claims rather than the detailed description, and all variations that fall within the equivalent scope of the claims should be interpreted as being included within the scope of the present invention.

What is claimed is:

1. A method for predicting an abnormality, the method comprising:
generating a feature map based on a previously captured omnidirectional image;
generating a masked image based on the feature map;
extracting a snippet feature based on the omnidirectional image;
extracting a frame feature based on the masked image; and
predicting a direction of an abnormality using the feature map and a combined feature obtained by combining the snippet feature and the frame feature.

2. The method for predicting an abnormality of claim 1,
wherein the omnidirectional image is converted into an image in which a region is divided according to a direction label assigned to the omnidirectional image.

3. The method for predicting an abnormality of claim 2,
wherein the predicting a direction of an abnormality comprises:
calculating a direction score corresponding to the direction label based on the combined feature;
calculating a pixel feature score in a grid by applying a feature map to the direction score; and
predicting the direction of the abnormality based on the pixel feature score.

4. The method for predicting an abnormality of claim 3,
wherein the predicting the direction of the abnormality comprises:
predicting the direction of the abnormality using a direction focus loss.

5. The method for predicting an abnormality of claim 1,
wherein the generating of the feature map comprises:
generating the feature map by identifying a dynamic region in the omnidirectional image.

6. The method for predicting an abnormality of claim 1,
wherein the generating of the masked image comprises:
dividing the feature map into grids;
calculating a feature score by summing pixel values in each cell of the grid;
selecting a plurality of upper cells having the highest score in the feature score; and
generating the masked image by masking cells other than the plurality of upper cells.

7. The method for predicting an abnormality of claim 1, further comprising:
calculating a snippet level feature based on the snippet feature;
calculating a coarse anomaly score using the snippet level feature; and
calculating a frame virtual label based on the coarse anomaly score.

8. The method for predicting an abnormality of claim 7,
wherein the calculating a frame virtual label comprises:
predicting an abnormality when the coarse anomaly score is equal to or greater than a threshold.

9. The method for predicting an abnormality of claim 8, further comprising:
extracting a frame-level feature based on the frame feature; and
calculating a fine anomaly score based on the frame-level feature.

10. The method for predicting an abnormality of claim 9, further comprising:
learning a loss function by using the frame virtual label calculation and the fine anomaly score.

11. An apparatus for predicting an abnormality comprising:
a processor comprising:
a generator configured to generate a feature map based on a previously captured omnidirectional image and generate a masked image based on the feature map;
a snippet level predictor configured to extract a snippet feature based on the omnidirectional image;
a frame level predictor configured to extract a frame feature based on the masked image; and
a direction predictor configured to predict a direction of an abnormality using the feature map and a combined feature obtained by combining the snippet feature and the frame feature.

12. The apparatus for predicting an abnormality of claim 11,
wherein the omnidirectional image is converted into an image in which a region is divided according to a direction label assigned to the omnidirectional image.

13. The apparatus for predicting an abnormality of claim 12,
wherein the direction predictor is configured to calculate a direction score corresponding to the direction label based on the combined feature, calculate a pixel feature score in a grid by applying a feature map to the direction score and predict the direction of the abnormality based on the pixel feature score.

14. The apparatus for predicting an abnormality of claim 13,
wherein the direction predictor is configured to predict the direction of the abnormality using a direction focus loss.

15. The apparatus for predicting an abnormality of claim 11,
wherein the generator is configured to generate the feature map by identifying a dynamic region in the omnidirectional image.

16. The apparatus for predicting an abnormality of claim 11,
wherein the generator is configured to divide the feature map into grids, calculate a feature score by summing pixel values in each cell of the grid, select a plurality of upper cells having the highest score in the feature score, and generate the masked image by masking cells other than the plurality of upper cells.

17. The apparatus for predicting an abnormality of claim 11,
wherein the snippet level predictor is configured to calculate a snippet level feature based on the snippet feature, calculate a coarse anomaly score using the snippet level feature, and calculate a frame virtual label based on the coarse anomaly score.

18. The apparatus for predicting an abnormality of claim 17,
wherein the snippet level predictor is configured to predict an abnormality when the coarse anomaly score is equal to or greater than a threshold.

19. The apparatus for predicting an abnormality of claim 18,
wherein the frame level predictor is configured to extract a frame-level feature based on the frame feature, and calculate a fine anomaly score based on the frame-level feature.

20. The apparatus for predicting an abnormality of claim 19,
wherein the frame level predictor is configured to learn a loss function by using the frame virtual label calculation and the fine anomaly score.
